(19) United States
(12) Patent Application Publication
(10) Pub. No.: US 2026/0366478 A1
(43) Pub. Date: Nov. 19, 2026

(54) FUEL PUMP

(71) Applicant: PHINIA DELPHI LUXEMBOURG SARL, Belvaux (LU)

(72) Inventor: Laurent Vincent, Saint Sulpice de Pommeray (FR)

(21) Appl. No.: 19/136,585

(22) PCT Filed: Nov. 23, 2023
(86) PCT No.: PCT/EP2023/082900

§ 371 Date: Jun. 6, 2025

(30) Foreign Application Priority Data
Dec. 13, 2022 (GB) 2218687.8

(51) Int. Cl. F02M 59/46; F02M 59/02; F04B 53/10

(52) U.S. Cl. CPC F02M 59/464; F02M 59/025; F04B 53/10

(57) ABSTRACT

A fuel pump and an outlet module for a fuel pump are provided. The fuel pump includes a main body and an outlet module. The main body defines: a pumping chamber with a pumping plunger arranged to reciprocate within the pumping chamber; an inlet passage at least indirectly connecting a low-pressure inlet of the fuel pump to the pumping chamber, an inlet valve being adapted to selectively enable flow through the inlet passage to the pumping chamber; and a receptacle, which is open towards a distal side and which extends into the main body along an outlet axis towards a proximal side so that the receptacle communicates with the pumping chamber (3). The outlet module is at least partially received in the receptacle, is connected to the main body in a fuel-tight manner, and includes: an outlet passage at least indirectly connecting the pumping chamber to a high-pressure outlet of the fuel pump, an outlet valve adapted to selectively enable flow through the outlet passage to the outlet, a relief passage at least indirectly connecting the outlet passage, downstream of the outlet valve, to the pumping chamber, and a relief valve adapted to selectively enable flow through the relief passage to the pumping chamber. In order to improve the design of a fuel pump with an integrated relief valve, the outlet module includes an outlet-valve body, which at least partially defines the outlet passage and which at least partially receives the outlet valve, and a relief-valve body, which at least partially defines the relief passage and which at least partially receives the relief valve, wherein the relief-valve body is at least partially received in an outlet-valve cavity of the outlet-valve body.

### FIELD OF THE INVENTION

The present invention relates to a fuel pump and to an outlet module for a fuel pump.

### BACKGROUND OF THE INVENTION

Fuel systems in modern internal combustion engines fueled by gasoline, particularly for use in the automotive market, mostly employ gasoline direct injection (GDI). In these systems, fuel injectors inject fuel directly into combustion chambers of the internal combustion engine. Commonly, fuel from a fuel tank is supplied under relatively low pressure by a low-pressure fuel pump which is typically an electric fuel pump located within the fuel tank. The low-pressure fuel pump supplies the fuel to a high-pressure fuel pump (also referred to as GDI pump), which typically includes a pumping plunger which is reciprocated by a camshaft of the internal combustion engine. During an intake stroke, fuel is sucked into the pumping chamber, and in a subsequent pumping stroke, the pumping plunger further pressurizes the fuel so that it can be supplied at high pressure to the fuel injectors.

For safe operation, the GDI pump includes a relief passage with an embedded relief valve to avoid any overpressure that could burst the pump or any part of the high-pressure system behind the pump (fuel rail, pipes and/or injectors) as well as limiting the pressure so that the pressure never reaches the injector Maximum Opening Pressure (MOP). In order to avoid backflow from the fuel rail into the pumping chamber, the fuel pump also comprises an outlet valve, which is disposed in an outlet passage on a high-pressure side of the pumping chamber. Integration of these valves into the fuel pump often leads to a complex design, and the various passages may weaken the overall structure of the fuel pump body. Another problem is that the design of relief valves and/or outlet valves in the art oftentimes only allows for checking the proper functionality late in the assembly process, when a single faulty part means that a major part of the fuel pump has to be scrapped.

### OBJECT OF THE INVENTION

The object of the present invention is to improve the design of a fuel pump with an integrated relief valve.

This object is achieved by a fuel pump according to claim 1 and by an outlet module according to claim 15.

### SUMMARY OF THE INVENTION

The present invention relates to a fuel pump. More specifically, it relates to a fuel pump for a combustion engine, in particular for a motor vehicle like a car. The fuel pump may be configured as a high-pressure pump, which receives fuel from a fuel tank via a low-pressure pump. The high-pressure pump then increases the pressure of the fuel, normally to at least 100 bar, sometimes up to 600 bar or even higher.

The fuel pump comprises a main body and an outlet module. The main body, which is normally at least partially made of metal to provide the necessary pressure resistance and stability, may be made of a single piece or (normally) several connected pieces. The main body defines an inlet passage, a pumping chamber and a receptacle, which are all volumes or spaces delimited by the main body.

The main body defines a pumping chamber with a pumping plunger arranged to reciprocate within the pumping chamber. By the action of the pumping plunger, fuel can be sucked into the pumping chamber during an intake stroke and can subsequently be pressurized and expelled from the pumping chamber during a compression stroke or pumping stroke. Accordingly, the fuel enters the pumping chamber at a low pressure and exits the pumping chamber at a high pressure. The pumping plunger can be operated electrically, or it may be mechanically linked to an engine, in particular to the combustion engine that the fuel pump supplies with fuel. E.g., the pumping plunger can be linked to a camshaft of the engine. Since the plunger reciprocates (i.e., moves back and forth) along a straight line, at least a portion of the pump chamber is cylindrical with a cross-section corresponding to that of the plunger. However, the pumping chamber may comprise at least one portion that is not accessible by the plunger and that may have a non-cylindrical shape. It is understood that the pumping chamber, as well as the passages mentioned hereinafter, are defined inside a housing of the fuel pump.

The main body further defines an inlet passage at least indirectly connecting a low-pressure inlet of the fuel pump to the pumping chamber, an inlet valve being adapted to selectively enable flow through the inlet passage to the pumping chamber. The low-pressure inlet is adapted for connection to a low-pressure fuel source, normally a low-pressure pump. Instead of “low-pressure inlet” this could simply be referred to as an “inlet”, while the term “low-pressure” indicates that the fuel entering the inlet has not yet been pressurized by the fuel pump. Of course, the connection to the fuel source can be indirect, e.g., via a pipe, a hose, or the like. The inlet passage establishes a fluid connection, or fluid communication, between the inlet and the pumping chamber, either directly or indirectly. In case of an indirect connection, the inlet passage is connected to another passage that is connected to the inlet. During an intake stroke of the plunger, fuel is sucked through the inlet passage into the pumping chamber. The term “passage” here and in the following refers to any volume that is suitable for containing fuel and allowing transfer of the fuel from an origin (in this case, the low-pressure inlet) to a destination (in this case, the pumping chamber). Such a passage may have various shapes, e.g., straight, curved and/or angled, and may be branched or unbranched. The inlet valve is adapted to selectively enable flow through the inlet passage to the pumping chamber. Advantageously, the inlet valve is a normally open valve, which can be selectively actuated into the closed position, in order to prevent fuel from flowing in the opposite direction, i.e., back towards the inlet passage. In other words, the pressure on an inlet side of the inlet valve is to be greater than the pressure on a pumping-chamber side by at least the specified opening pressure. Additionally, the opening of the inlet valve may be assisted/controlled by an actuator. The inlet valve can be disposed on or inside the inlet passage, for example close to the inlet, close to the pumping chamber or somewhere in between. In order to minimize the pumping dead volume, it is highly preferred that the inlet valve is disposed close to the pumping chamber. The inlet valve can be received inside the main body or can be regarded as a part of the main body.

Furthermore, the main body defines a receptacle, which is open towards a distal side, and which extends into the main body along an outlet axis towards a proximal side so that the receptacle communicates with the pumping chamber. The receptacle is a recess inside the main body. More specifically, it is an open recess, i.e., it is open towards a distal side (the main body having a receptacle opening at this distal side). The receptacle extends into the main body along an outlet axis towards a proximal side, which is opposite the first side with respect to the outlet axis. More specifically, it extends into the main body so that it communicates with the pumping chamber. In other words, the pumping chamber and the receptacle are directly or indirectly connected.

The outlet module is at least partially received in the receptacle and is connected to the main body in a fuel-tight manner.

The outlet module comprises an outlet passage that at least indirectly connects the pumping chamber to a high-pressure outlet of the fuel pump. The outlet passage is either directly or indirectly connected to the pumping chamber and is either directly or indirectly connected to the high-pressure outlet. Instead of “high-pressure outlet”, this could simply be referred to as an “outlet”, while the term “high-pressure” indicates that the fuel exiting the outlet has been pressurized by the fuel pump. In assembled state, the outlet may be connected to a fuel rail which in turn is connected to a plurality of fuel injectors. During a pumping stroke, fuel is pressurized in the pumping chamber and then expelled from the pumping chamber through the outlet passage.

Further, the outlet module comprises an outlet valve that is adapted to selectively enable flow through the outlet passage to the outlet. The outlet valve is normally a one-way valve (check-valve type) that prevents fuel from flowing in the opposite direction, i.e., towards the pumping chamber. Also, the outlet valve may only enable flow towards the outlet if a certain opening pressure is exceeded. The outlet valve can be disposed inside the outlet passage, for example close to the outlet, close to the pumping chamber or somewhere in between. In order to minimize the pumping dead volume, it is highly preferred that the outlet valve is disposed close to the pumping chamber.

The outlet module also comprises a relief passage that at least indirectly connects the outlet passage, downstream of the outlet valve, to the pumping chamber. The relief passage originates (directly or indirectly) from the outlet passage downstream of the outlet valve and leads (directly or indirectly) to the pumping chamber. Accordingly, fuel can be released from the outlet passage into the pumping chamber through the relief passage. The function of the relief passage is to prevent excessive overpressure in the outlet passage and/or for example a fuel rail connected to the outlet passage.

Furthermore, the outlet module comprises a relief valve that is adapted to selectively enable flow through the relief passage to the pumping chamber. The relief valve is adapted to selectively enable flow through the relief passage towards the pumping chamber. More specifically, the relief valve is a one-way valve that prevents fuel from flowing in the opposite direction, i.e., towards the outlet passage. Also, the relief valve only enables fuel flow towards the pumping chamber if a certain opening pressure is exceeded. In other words, if the pressure difference between the outlet passage and the pumping chamber is high enough, the relief valve opens to release fuel from the outlet passage through the relief passage. The relief valve can be disposed inside the relief passage, for example close to the outlet passage, close to the pumping chamber or somewhere in between.

The outlet module comprises the outlet passage, the relief passage, the outlet valve, and the relief valve. In other words, the outlet passage, the relief passage, and the corresponding valve mechanisms are combined in the outlet module. The outlet module, in turn, is fully or at least partially received in the receptacle. It is understood that the design of the outlet module and its position inside the receptacle are adapted so that the outlet passage and the relief passage can communicate with the pumping chamber as described above. In order to prevent any fuel leakage through the receptacle, the outlet module is connected to the main body in a fuel-tight manner.

According to the invention, the outlet module comprises an outlet-valve body, which at least partially defines the outlet passage and which at least partially receives the outlet valve, and a relief-valve body, which at least partially defines the relief passage and which at least partially receives the relief valve, wherein the relief-valve body is at least partially received in an outlet-valve cavity of the outlet-valve body. The outlet-valve body and the relief-valve body are separately manufactured bodies. Each of these bodies is normally made of a single piece. They are normally made of metal, e.g., stainless steel. Generally speaking, the terms “outlet-valve body” and “relief-valve body” are used for distinction and are not to be construed in any limiting way. However, since the outlet-valve body at least partially receives the outlet valve, it is associated therewith. At least a part and/or a portion of the outlet valve is received in the outlet-valve body, i.e., it is disposed therein. Optionally, the entire outlet valve may be received in the outlet-valve body. In other embodiments, the outlet-valve body, or a portion thereof, may also form a part of the outlet valve. The outlet-valve body may form a housing for at least some elements of the outlet valve. As a rule, the outlet-valve body is at least partially disposed inside the receptacle. Furthermore, the outlet-valve body at least partially defines the outlet passage. In some embodiments, a part of the outlet passage may be defined by a different element. At least a part of the outlet passage may be a cavity or recess inside the outlet-valve body. At least a part and/or a portion of the relief valve is received in the relief-valve body, i.e., it is disposed therein. Optionally, the entire relief valve may be received in the relief-valve body. In other embodiments, the relief-valve body, or a portion thereof, forms a part of the relief valve. The relief-valve body may form a housing for at least some elements of the relief valve. It is possible that the relief-valve body and the relief valve together form a relief-valve module or relief-valve assembly. The relief-valve body at least partially defines the relief passage. In some embodiments, a part of the outlet passage may be defined by a different element, e.g. by the outlet-valve body. At least a part of the relief passage may be a cavity or recess inside the relief-valve body.

The relief-valve body is at least partially received in an outlet-valve cavity of the outlet-valve body. Again, the term “outlet-valve cavity” is not to be construed in that the outlet valve has to be received inside this cavity, although this is possible. The relief-valve body is fully or partially disposed inside the outlet-valve cavity. During assembly, it is at least partially inserted into this cavity. In some embodiments, the above-mentioned relief-valve module may be preassembled and then afterwards be inserted into the outlet-valve cavity.

The inventive design allows for an integration of the outlet and pressure relief functions in a single outlet module that can be produced and assembled separately from the main body. It is possible to test the proper functions of the outlet module, in particular the functions of the outlet valve and the relief valve before the outlet module is inserted into the receptacle. Accordingly, production errors or assembly errors can be identified before the final assembly of the fuel pump, which greatly helps to reduce scrap. In the worst case, only a faulty outlet module has to be replaced. Moreover, it may even be possible to replace only part of the outlet module, thereby further reducing scrap. For instance, it may be possible to replace only the relief valve, the relief-valve body or the entire relief-valve module. It is also conceivable that the relief-valve module is tested before it is inserted into the outlet-valve cavity. Also, integration of the relief passage into the outlet module decreases the need for machining operations on the main body. In fuel pumps known in the art, the relief passage often represents a structural weak point of the main body. This weak point is removed by the inventive design. Integration of the relief passage into the outlet module often allows for a design that does not weaken the structure of the outlet module in a comparable way.

According to a preferred design, the outlet module comprises an outer threading engaging an inner threading of the main body inside the receptacle, the inner and outer threading being concentrically disposed around the outlet axis. During assembly, the outlet module is screwed into the receptacle as the inner threading and outer threading engage. Since these threadings are concentric with respect to the outlet axis, a considerable axial force (in the direction of the outlet axis) can be exerted between the main body and the outlet module. This axial force can be used to provide a fuel-tight seal between the main body of the outlet module. The screw connection is favorable e.g., compared to a welding connection, which could induce thermal stress and lead to distortion of the main body and/or the outlet module.

Specifically, the outlet module may comprise a first sealing portion that engages a second sealing portion of the main body inside the receptacle. Preferably, at least one sealing portion comprises an annular knife-edge element that cuts into the other sealing portion to create a knife-edge seal. In this embodiment, the outlet module and the main body comprise corresponding sealing portions which directly engage each other to provide the fuel-tight seal. One of the sealing portions comprises an annular knife-edge element, which usually has a pointed, wedge-like or blade-like profile. The knife-edge element is annular and preferably concentric about the outlet axis. This can be particularly advantageous in combination with the abovementioned embodiment in which the outlet module is screwed into the receptacle. By the screwing action between the first and second threading, the knife-edge element on one sealing portion is rotated about the outlet axis with respect to the other sealing portion while it is also pressed axially against the other sealing portion. The hardness of the knife-edge element is sufficient so that it cuts into the other sealing portion, thereby providing a knife-edge seal. Preferably, the knife-edge element cuts axially into the other sealing portion. This kind of seal is known to be extremely reliable and resistant to high pressure.

In embodiments, the outlet-valve body can be directly connected to the main body. For instance, the outlet-valve body could comprise the outer threading. According to a preferred embodiment, though, the outlet module comprises an outlet fitting in which the outlet-valve body is at least partially received and which is connected to the main body. In this case, the connection of the outlet module to the main body is established at least partially or even exclusively via the outlet fitting. While the relief-valve body is at least partially received inside the outlet-valve body, the outlet-valve body is at least partially received inside the outlet fitting. Accordingly, the outlet module has a nested structure. Preferably, the outlet fitting comprises a proximal opening on the proximal side, through which the outlet-valve body is inserted during assembly. As a rule, the outlet fitting is at least partially received inside the receptacle. It is highly preferred that the outlet fitting comprises the above-mentioned outer threading. Furthermore, it preferably comprises the above-mentioned first sealing portion.

The connection between the relief-valve body and the outlet-valve body could be established in various ways. For example, it could be established via cooperating threadings that engage each other, by welding or soldering. However, the relief-valve body is preferably press-fitted into the outlet-valve body. This option provides a fluid-tight connection while at the same time ensuring a pressure resistant mechanical connection avoiding e.g., a welding operation which could lead to distortion or thermal stress. In order to provide a particularly reliable connection, the relief-valve body and the outlet-valve body may comprise corresponding stepped surfaces that cooperate to provide the press-fit. Specifically, the relief-valve body may comprise a first proximal press-fit surface, which engages a second proximal press-fit surface of the outlet-valve body, and a first distal press-fit surface, which engages a second distal press-fit surface of the outlet-valve surface and which radially protrudes with respect to the first proximal press-fit surface. It will be understood that the first (or second, respectively) proximal press-fit surface is disposed proximally, i.e., towards the proximal side, with respect to the first (or second, respectively) distal press-fit surface. Each of the above-mentioned press-fit surfaces is normally parallel to the outlet axis or inclined by less than 2° or less than 1° with respect to the outlet axis.

A particularly preferred embodiment provides that at least one of the outlet-valve body, the relief-valve body and the outlet fitting is made of a single piece. Preferably, each of these three elements is made of a single piece. In other words, a single piece (of metal) is used for the respective element, which normally undergoes various machining operations, e.g., for providing the outlet-valve cavity, the outer threading (if present) or other features. However, at least some features can be defined by an initial casting process. The single-piece design facilitates assembly of the outlet module and increases the structural stability of the individual element.

It is also preferred that the outlet-valve body is press-fitted into the outlet fitting. Again, this enables a fluid-tight connection while at the same time avoiding distortion or thermal stress. In order to provide a particularly reliable connection, the outlet-valve body and the outlet fitting may comprise corresponding stepped surfaces. Specifically, the outlet-valve body may comprise a third distal press-fit surface, which engages a fourth distal press-fit surface of the outlet fitting, and a third proximal press-fit surface, which engages a fourth proximal press-fit surface of the outlet fitting and which radially protrudes with respect to the third distal press-fit surface. It will be understood that the third (or fourth, respectively) distal press-fit surface is disposed distally, i.e., towards the distal side, with respect to the third (or fourth, respectively) proximal press-fit surface. Each of the above-mentioned press-fit surfaces is normally parallel to the outlet axis or inclined by less than 2° or less than 1° with respect to the outlet axis.

Preferably, at least one press-fit connection is achieved using at least two pairs of cooperating surfaces, which pairs of surfaces are axially and radially offset relative to each other. This may pertain to the press-fit connection between the relief-valve body with the outlet-valve body. Alternatively or additionally, it may pertain to the press-fit connection between the outlet-valve body and the outlet fitting. The reliability and the tightness of the connection can be enhanced if one pair of surfaces is radially and axially offset to another pair of surfaces. At least in some embodiments, the respective combination of two offset pairs of surfaces may also be referred to as a stepped press-fit structure.

As mentioned above, the relief-valve body may form a kind of housing for the relief valve. According to one embodiment, the relief-valve body comprises a relief-valve cavity with a first distal insertion opening on the distal side, through which the relief valve is at least partially inserted into the relief-valve cavity during assembly. In this context, “partially” refers to the possibility that the relief valve is not fully inserted into the relief-valve cavity, as well as to the possibility that a part of the relief-valve may be formed by the relief-valve body itself. The first distal insertion opening is designed to allow for the relief valve (or a part thereof) to be inserted into the outlet-valve body. It is disposed on the distal side, which means that the relief valve is moved towards the proximal side as it is inserted. If, as is usually the case, the relief valve comprises several components, these can be pre-assembled outside of the relief-valve body before they are inserted. Normally, the relief valve is inserted into the relief-valve cavity before the relief-valve body is inserted into the outlet-valve cavity. However, this is not essential for this embodiment.

Preferably, the relief valve comprises a first seat member, a first valve member and a first spring member for biasing the first valve member against the first seat member, the first valve member and the first spring member being disposed in the relief-valve cavity and the first seat member being press-fitted into the relief-valve cavity. The first valve member and the first seat member cooperate to provide the valve mechanism, wherein the first seat member represents the stationary part of the relief valve and the first valve member represents the movable part. The first spring member acts directly or indirectly between the first seat member and the first valve member. By the action of the first spring member, the first valve member is biased against the first seat member into a closed position of the relief valve. Accordingly, a force acting on the first valve member due to a pressure difference has to overcome the force of the first spring member to move the first valve member into an open position, thereby opening the relief valve. The first valve member and the first spring member are received inside the relief-valve cavity, wherefore they are encased in the relief-valve body. The first seat member is press-fitted into the relief-valve cavity, thereby providing a firm and fluid-tight connection while at the same time avoiding e.g., a welding operation which could lead to distortion or thermal stress.

In embodiments the first valve member is at least mostly disposed on the proximal side of the first seat member and engages the first seat member from the proximal side in a closed position of the relief valve, and the first spring member is disposed on the proximal side of the first seat member and engages a first abutment surface of the relief-valve body. In this embodiment, the first seat member partially closes the relief-valve cavity on the distal side and represents an abutment for the first valve member on the distal side. The first spring member can engage the first valve member from the proximal side. On the distal side, the first spring member rests against the first abutment surface, which is part of the relief-valve body. Effectively, the movable parts of the relief valve (the first valve member and the first spring member) are interposed between the first abutment surface and the first seat member. Normally, the first valve member is disposed entirely on the proximal side of the first seat member, but a minor portion of the first valve member may e.g., protrude into a through-opening of the first seat member that allows for fuel flow through the relief-valve in its open state.

The outlet-valve body may comprise a second distal insertion opening on the distal side, through which the outlet valve and the relief-valve body are at least partially inserted into the outlet-valve cavity during assembly. The second distal insertion opening communicates with the outlet-valve cavity (or can be regarded as a part thereof). It is designed to allow for the relief-valve body (or the relief-valve module) to be inserted into the outlet-valve body. It is disposed on the distal side, wherefore the outlet valve and the relief-valve body can be inserted from the distal side, with a movement towards the proximal side. As indicated above, the relief-valve body can be pre-assembled with the relief valve to form a relief-valve module, which may then be inserted through the second distal insertion opening. Preferably, the relief-valve body is inserted after the outlet valve. Thus, in assembled state, the relief-valve body is disposed on the distal side of the outlet valve.

Preferably, the outlet valve comprises a second seat member, a second valve member and a second spring member for biasing the second valve member against the second seat member. Again, the second seat member represents the stationary part of the outlet valve, and the second valve member represents the movable part. The second spring member acts directly or indirectly between the second seat member and the second valve member, thereby biasing the second valve member against the second seat member into a closed position of the outlet valve. Accordingly, a force acting on the second valve member according to a pressure difference has to overcome the force of the second spring member to move the second valve member into an open position, thereby opening the outlet valve. It is preferred that the second spring member engages a second abutment surface of the relief-valve body. In other words, the second spring member rests against the second abutment surface, which is a part of the relief-valve body. This is beneficial in that the relief-valve body not only has a function related to the relief channel and the relief valve, but also one that is related to the outlet valve. During assembly, the second valve member and the second spring member can be inserted into the outlet-valve cavity, whereafter the relief-valve body is inserted to provide an abutment for the second spring member.

The second seat member could be made as a dedicated element which is connected to the outlet-valve body, e.g., by press-fitting. A preferred embodiment provides that the outlet-valve body forms the second seat member. This reduces the number of elements and facilitates the assembly process. The second seat member may be a flange portion of the outlet-valve body that protrudes radially inwards. It will be understood that this embodiment is made possible by inserting the movable parts of the outlet valve (i.e., the second valve member and the second spring member) from one side (normally the distal side), which is then at least partially closed or blocked by the inserted relief-valve body.

In embodiments, the outlet passage comprises a proximal portion, in which the outlet valve is at least partially received, a distal portion, and a plurality of intermediate portions connecting the proximal portion and the distal portion, the outlet axis traversing the proximal portion and the distal portion and the intermediate portions being offset from the outlet axis. As a rule, the proximal portion is furthest away from the outside of the main body. The proximal portion may be disposed adjacent to the inlet passage. The outlet valve is at least partially received in the proximal portion. The distal portion is normally disposed furthest away from the inlet passage and either closest to the outlet or even comprises the outlet. In some embodiments, the relief-valve body may be at least partially received in the distal portion. The proximal portion and the distal portion are connected by a plurality of intermediate portions, e.g., between two and eight, preferably between three and six, intermediate portions. While the outlet axis traverses the proximal and distal portion, the intermediate portions are disposed offset from the outlet axis, one could say radially offset from the outlet axis. This may facilitate a compact design of the outlet module since the offset arrangement of the intermediate portions allows for other elements to be arranged near or on the outlet axis. In particular, the intermediate portions may be disposed radially outside of the outlet-valve cavity, in an axial position that partially overlaps that of the relief-valve body. One could say that the intermediate portions bypass the relief-valve body. It is even possible that the axial position of the proximal portion and/or the distal portion overlaps with the axial positions of the intermediate portions, with the intermediate portions being disposed radially outside of the proximal portion and/or the distal portion. According to one embodiment, the intermediate portions extend parallel to the outlet axis. This facilitates production of the outlet-valve body, since the intermediate portions can e.g., be drilled by parallel drilling operations.

The relief passage may comprise a valve portion inside the relief-valve cavity adjacent to the relief valve, at least one first traverse portion connected to the valve portion and traversing the relief-valve body to an outside thereof, and at least one second traverse portion communicating with at least one first traverse portion, traversing the outlet-valve body to an outside thereof and communicating with the pump chamber. The valve portion is normally disposed near the outlet axis and may be symmetric thereto. It is disposed adjacent to the relief valve and the relief valve is normally in direct communication with the valve portion. It is disposed inside the relief-valve cavity, i.e., it is a part of the relief-valve cavity. The at least one first traverse portion traverses the relief-valve body and normally extends radially outwards from the valve portion. There may be a plurality of first traverse portions which diverge/split off from the valve portion and constitute individual connections between the main portion and the outside of the relief-valve body. They may be disposed symmetrical with respect to the outlet axis. The at least one second traverse portion traverses the outlet-valve body and normally extends radially outwards from the outlet-valve cavity. There may be a plurality of second traverse portions. They may be disposed symmetrical with respect to the outlet axis. One second traverse portion may be tangentially and axially aligned with one first traverse portion. In some embodiments, the axial positions of the second traverse portions may overlap with those of the intermediate portions. In this case, the different portions are tangentially offset from each other to avoid any interference.

In embodiments, at least one of the outlet valve, the relief valve and the outlet passage is at least mostly symmetrical to the outlet axis. “At least mostly symmetrical” means that some (minor) parts may not be symmetrical, but the overall configuration is symmetrical. The symmetric design may facilitate the production as well as the assembly of the outlet module. Also, it may help to optimize the fuel flow through the outlet module. Regarding the relief valve, it is preferred that the first valve member, the first seat member and the first spring member each are symmetrical to the outlet axis. The same applies to the second valve member, the second seat member and the second spring member of the outlet valve. In this context, a coil spring is considered to be symmetrical to the outlet axis if its spring axis coincides with the outlet axis. If the outlet passage has a proximal portion, a distal portion and intermediate portions, the intermediate portions may be disposed on a circle concentric to the outlet axis and evenly spaced along the tangential direction.

The invention also relates to an outlet module for a fuel pump comprising a main body, which defines:
a pumping chamber with a pumping plunger arranged to reciprocate within the pumping chamber;
an inlet passage at least indirectly connecting a low-pressure inlet of the fuel pump to the pumping chamber, an inlet valve being adapted to selectively enable flow through the inlet passage to the pumping chamber; and
a receptacle, which is open towards a distal side and which extends into the main body along an outlet axis towards a proximal side so that the receptacle communicates with the pumping chamber.

The outlet module is adapted to be at least partially received in the receptacle, is connected to the main body in a fuel-tight manner, and comprises:
an outlet passage at least indirectly connecting the pumping chamber to a high-pressure outlet of the fuel pump,
an outlet valve adapted to selectively enable flow through the outlet passage to the outlet,
a relief passage at least indirectly connecting the outlet passage, downstream of the outlet valve, to the pumping chamber, and
a relief valve adapted to selectively enable flow through the relief passage to the pumping chamber.

According to the invention, the outlet module comprises an outlet-valve body, which at least partially defines the outlet passage and which at least partially receives the outlet valve, and a relief-valve body, which at least partially defines the relief passage and which at least partially receives the relief valve, wherein the relief-valve body is at least partially received in an outlet-valve cavity of the outlet-valve body.

### BRIEF DESCRIPTION OF THE DRAWINGS

The present invention will now be described, by way of example, with reference to the accompanying drawings, in which:

FIG. 1: is a sectional view of an inventive fuel pump;

FIG. 2: is a sectional view of a detail of the fuel pump of FIG. 1 with an outlet module;

FIG. 3: is a sectional view of the outlet module of FIG. 2;

FIG. 4: is a perspective cutaway view of parts of a relief-valve module of the outlet module of FIG. 2;

FIG. 5: is a perspective cutaway view of the relief-valve module, parts of an outlet-valve and an outlet-valve body of the outlet module of FIG. 2; and

FIG. 6: is a perspective view of parts of the outlet module from FIG. 2.

### DETAILED DESCRIPTION OF PREFERRED EMBODIMENTS

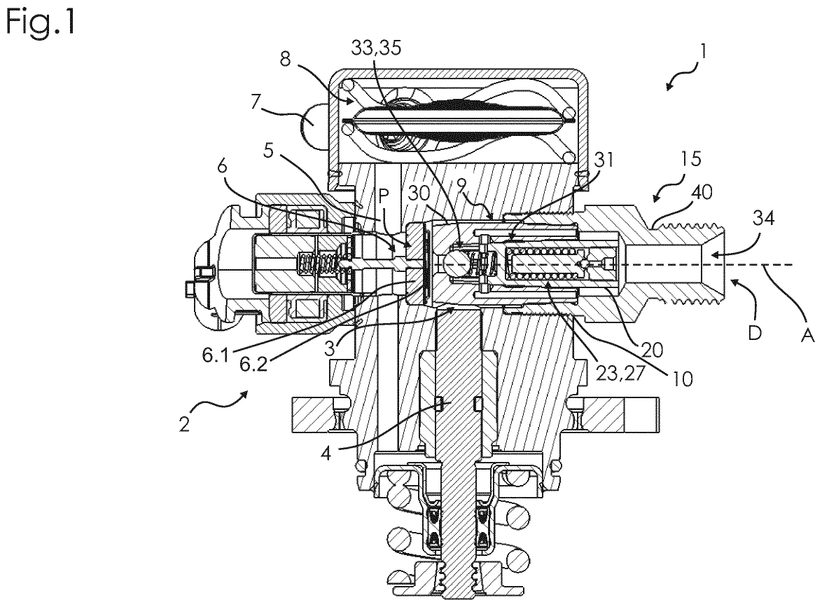

FIG. 1 shows an embodiment of the present fuel pump 1 with an embodiment of the inventive outlet module 15. The general structure and operating principle of the fuel pump 1 are generally known and thus will only be briefly described here. Fuel pump 1 is typically part of a fuel system (not shown) of an internal combustion engine, which generally includes a fuel tank holding a volume of fuel to be supplied to the engine for operation thereof. A low-pressure fuel pump draws fuel from fuel tank and elevates the pressure of the fuel (e.g. up to 5 bar) for delivery to the (high-pressure) fuel pump 1 which in turn further elevates the pressure of the fuel (e.g. to between 10 bar an 50 bar) for delivery to the fuel injectors, which then directly inject the fuel into the combustion chambers of the cylinders of the engine.

The fuel pump 1 comprises a main body 2 with various parts, most of which are made of metal, e.g., stainless steel. The main body 2 defines a pumping chamber 3 with a pumping plunger 4, which is adapted to reciprocate within the pumping chamber and may be mechanically linked to a rotating camshaft (not shown) of the engine. The pumping chamber 3 is connected to an inlet passage 5 with an inlet valve 6. Conventionally, the inlet passage 5 is connected to a low-pressure inlet 7 of the fuel pump 1, via which the fuel pump 1 can be connected to the abovementioned low-pressure pump. Fuel enters the pump 1 via the low-pressure inlet 7, flows through a damping volume 8, which is defined by a damper cup mounted to the main body 2, as is known in the art, and then enters the inlet passage 5. Although not shown in detail, the inlet valve 6 typically comprises a seat member 6.1 defining one or more flow orifices that can be sealed by a flexible disk valve member 6.2 that can be raised from the seat member by means of an actuating rod controlled by a solenoid actuator. This is only one conventional example of inlet valve and should not be construed as limiting.

The main body 2 also defines a receptacle 9 that is aligned along an outlet axis A and opens to an outside of the main body 2 at a receptacle opening 10. The receptacle opening 10 is disposed on a distal side D with respect to the outlet axis A, and the receptacle extends into the main body 2 towards a proximal side P so that it communicates with the pumping chamber 3. An inventive outlet module 15 is partially received in the receptacle 9. The outlet module 15 comprises a relief-valve body 20, an outlet-valve body 30 and an outlet fitting 40, each of which is made of a single piece of stainless steel. These elements will be described in detail below. An outlet passage 33, which is partially defined by the outlet-valve body 30, connects the pumping chamber 3 to a high-pressure outlet 34 of the fuel pump 1. A relief passage 27, which is partially defined by the relief-valve body 20, connects the outlet passage 33 to the pumping chamber 3. The outlet module 15 comprises a relief valve 23 and an outlet valve 35. The outlet valve 35 is a one-way valve that enables fuel flow from the pumping chamber 3 to the outlet 23 if the pressure difference between the pumping chamber 3 and the outlet passage 33 (or rather, the portion downstream of the outlet valve 35) exceeds a predefined outlet pressure. The relief valve 23 also is a one-way valve that enables flow from the outlet passage 33 through the relief passage 27 to the pumping chamber 3 if the pressure in the outlet passage 33 exceeds the pressure in the pumping chamber 3 and the difference is greater than a defined relief opening pressure.

During operation, the reciprocating movement of the pumping plunger 4 causes fuel to be drawn from the inlet passage 5 into the pumping chamber 3 during an intake stroke. During a pumping or compression stroke, the fuel in the pumping chamber 3 is pressurized and expelled through the outlet valve 35 and the outlet passage 33. The fuel can then be supplied via the outlet 34 to a fuel rail that is connected to the above-mentioned injectors. During the compression stroke, the inlet valve 6 is selectively closed and prevents backflow through the inlet passage 5. If at any time the pressure in the outlet passage 33 exceeds the predefined relief opening pressure, the relief valve 23 opens to release fuel from the outlet passage 33 through the relief passage 30 into the pump chamber 3, thereby preventing possible damage to any components downstream of the fuel pump 1.

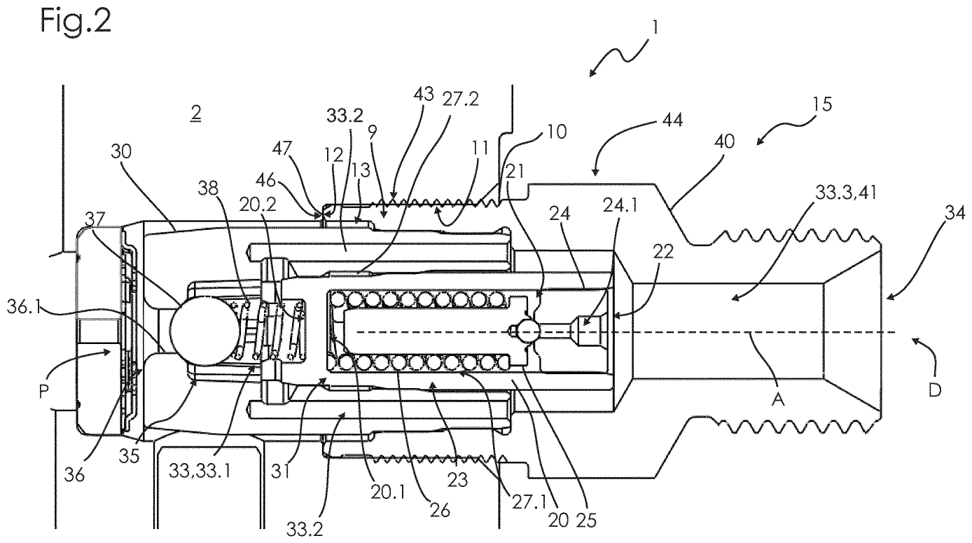

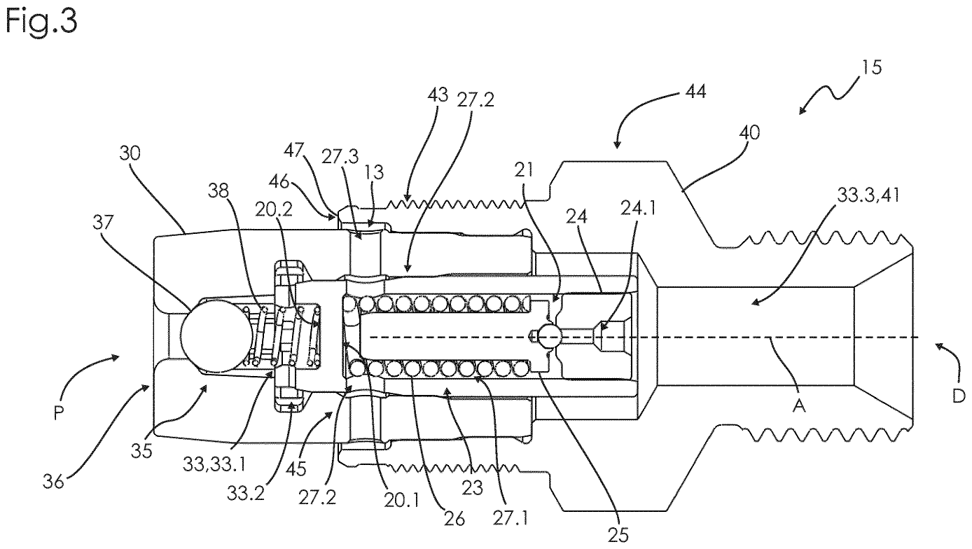

Details of the outlet module 15 will now be discussed with reference to FIGS. 2 to 6. The outlet module 15 is symmetrical with respect to the outlet axis A. It comprises an outer threading 43 that is concentric to the outlet axis A and engages a corresponding inner threading 11 on an inside of the receptacle 9. During assembly, the outlet module 15 is inserted through the receptacle opening 10 and is screwed into the receptacle 9 by the cooperation of the above-mentioned threadings 11, 43. To facilitate screwing, the outlet module 15 comprises an outer hexagonal drive profile 44. At the end of the screwing process, a first sealing portion 46 of the outlet module 15 engages a second sealing portion 12 of the main body 2. Specifically, the first sealing portion 46 comprises an annular knife-edge element 47 that cuts into the second sealing portion 12 to provide a knife-edge seal. Accordingly, the outlet module 15 is connected to the main body 2 in a fuel-tight manner without the need for a welding operation that could lead to thermal stress and deformation. In this embodiment, the outer threading 43, the drive profile 44, the first sealing portion 46 and the knife-edge element 47 are parts of the outlet fitting 40.

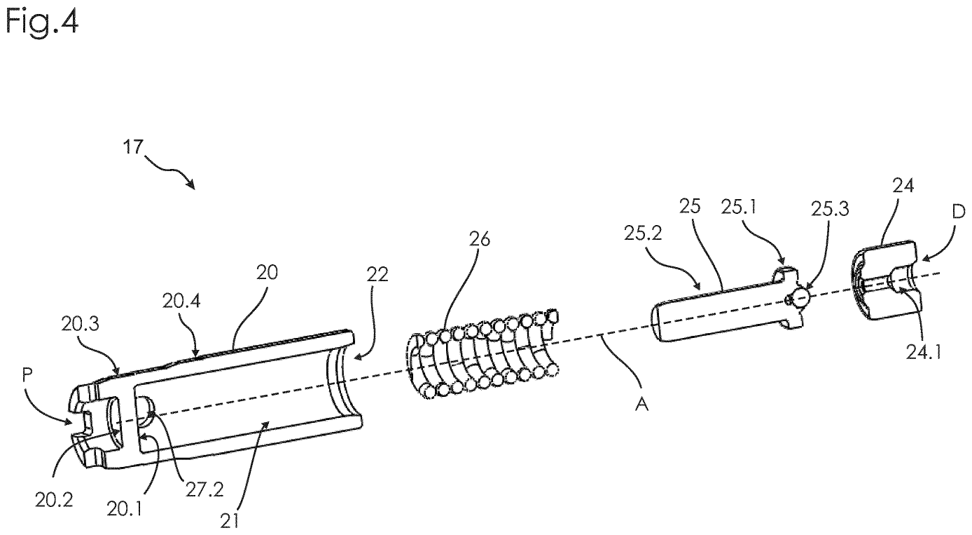

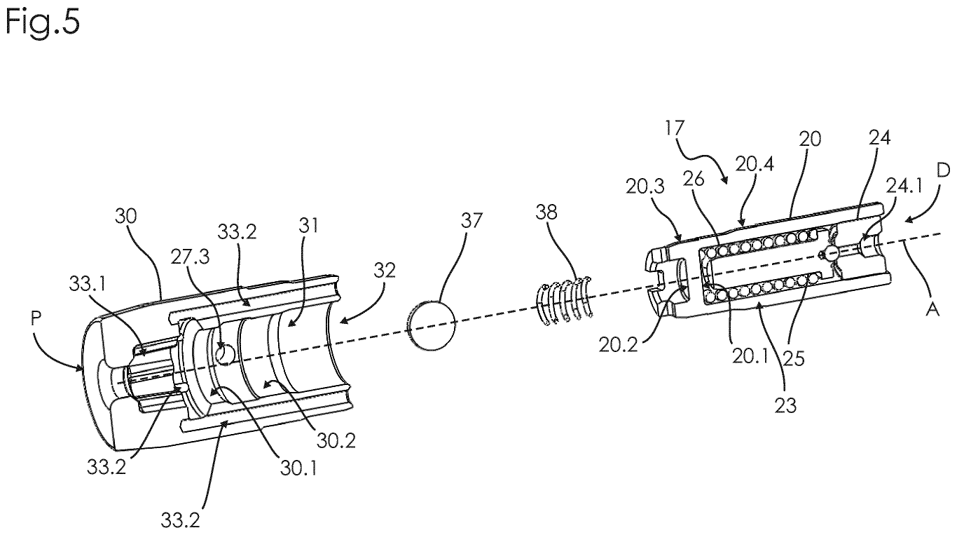

The relief-valve body 20 and the relief valve 23 are parts of a relief-valve module 17, which can best be seen in FIGS. 4 and 5. The relief-valve body 20 defines a relief-valve cavity 21, in which a first seat member 24 with axial through bore 24.1, a first valve member 25 and a first spring member 26 of the relief valve 23 are received. These elements are shown separately in FIG. 4. During assembly, the first spring member 26 and the first valve member 25 are inserted into the relief-valve cavity 21 through a first distal insertion opening 22 so that the first spring member rests against a first abutment surface 20.1 of the relief-valve body 20. The first seat member 24 is then press-fitted into the relief-valve body 20, thereby enclosing the first spring member 26 and the first valve member 25 inside the relief-valve cavity 21. The press-fit provides a metal-to-metal seal, preventing fuel flow around the first seat member 24. Apart from receiving the relief valve 23, the relief-valve cavity 21 also forms a valve portion 27.1 of the relief passage 27, which will be discussed further below.

In this embodiment, first valve member 25 comprises an elongate shaft 25.2 (extending parallel to the outlet axis A), a radially protruding head 25.1 at a distal end of the shaft 25.2 and a ball 25.3 on the distal side D of the head 25.1. The shaft 25.2 extends through the first spring member 26, which abuts the the head 25.1. In the closed position of the relief valve 23 shown in FIGS. 1 to 3, the ball 25.3 engages the first seat element 24 from the proximal side P, where it is thus subjected to the pressure in the pumping chamber 3. Although, most of the relief valve 23 is in a region that communicates with the pump chamber 3, the dimensions of the first valve member 25 and the first spring member 26 are chosen so that the dead volume is minimized.

In the figures, the first valve member 25 is shown in its closed position, in which the ball 25.3 rests against the first seat member 24 due to the biasing force the first spring member 26, hence closing through bore 24.1. If the force acting on the first valve member 25 due to a pressure difference between the proximal side P (pump-chamber side) and the distal side D (outlet side) of the seat member 24 overcomes the spring force, the first valve member 25 moves to the proximal side P (i.e., proximally) and the relief valve 23 opens. The spring force in the closed position can be calibrated by adapting the position of the first seat member 24 as it is press-fitted into the relief-valve cavity 21. The relief-valve body 20 and the relief valve 23 can be pre-assembled to form the relief-valve module 17 shown in FIG. 5, so that the properties of the relief valve 23 can be tested before the outlet module 15 is assembled or installed into the receptacle 9.

The relief passage 27 comprises the above-mentioned valve portion 27.1 centrally disposed on the outlet axis A and two first traverse portions 27.2 that originate from the main portion 27.1 and traverse the relief-valve body 20 radially in opposite directions. Each first traverse portion 27.2 is aligned with one of a pair of second traverse portions 27.3, which traverse the outlet-valve body 30 radially. The second traverse portions 27.3 are connected to an annular chamber 13, which is defined inside the receptacle 9 between the main body 2 and the outlet-valve body 30 and which is directly connected to the pumping chamber 3.

As seen in FIG. 5, the relief-valve module 17 is mainly received inside an outlet-valve cavity 31 of the outlet-valve body 30. During assembly, it is inserted through a second distal insertion opening 32 and the relief-valve body 20 is press-fitted into the outlet-valve cavity 31. Specifically, a first proximal press-fit surface 20.3 of the relief-valve body 20 engages a second proximal press-fit surface 30.1 of the outlet-valve body 30 and a first distal press-fit surface 20.4 of the relief-valve body 20 engages a second distal press-fit surface 30.2 of the outlet-valve body 30, wherein the distal press-fit surfaces 20.4, 30.2 are disposed radially outwards of the proximal press-fit surfaces 20.3, 30.1. Consequently, a stepped press-fit structure is formed which results in a very tight connection, providing strong mechanical connection as well as a fluid tight seal.

In addition to the relief-valve module 17, a second spring member 38, which is a coil spring, and a second valve member 37 of the outlet valve 35 are received in the outlet-valve cavity 31. During assembly, the ball-shaped second valve member 37 is inserted first, before the second spring member 38 is inserted and finally the relief-valve module 17 is press fitted into the outlet-valve cavity 31. A portion of the outlet-valve body 30 that protrudes radially inwards forms a second seat member 36 provided with an axial through bore 36.1. When the relief-valve module 17 is installed, the second spring member 38 is compressed between the second valve member 37 and a second abutment surface 20.2 of the relief-valve body 20. In FIGS. 1 to 3, the second valve member 37 is biased by the second spring member 38 against the second seat member 36, closing axial through bore 36.1; this is the closed position of the outlet valve 35.

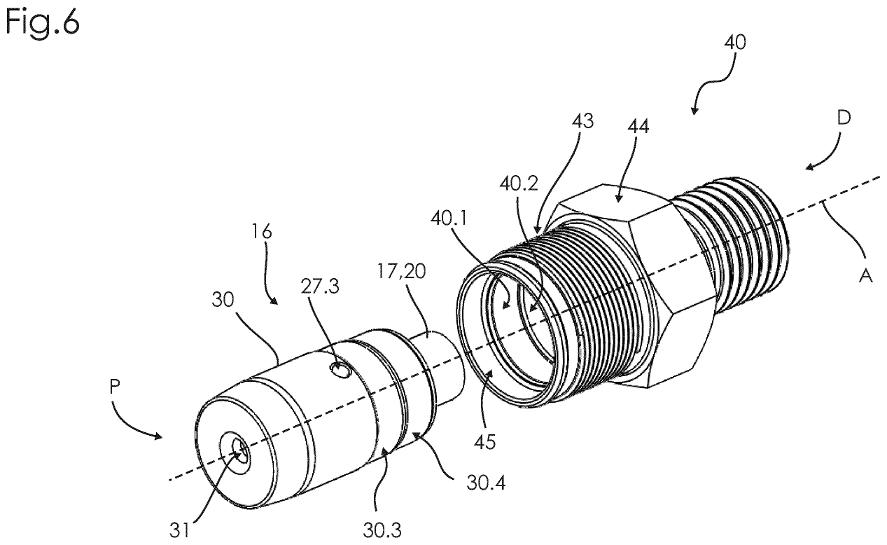

During assembly, the second valve member 37, the second spring member 38 and the relief-valve module 17 are assembled with the outlet-valve body 30 to form a dual-valve assembly 16 shown in FIG. 6. It is possible to test this dual-valve assembly 16, including the function of the outlet valve 35 and relief valve 23, before assembly continues. Subsequently, the outlet-valve body 30 is inserted through a proximal insertion opening 45 of outlet fitting 40 and press-fitted into the fitting cavity 41. Specifically, a third proximal press-fit surface 30.3 of the outlet-valve body 30 engages a fourth proximal press-fit surface 40.1 of the outlet fitting 40 and a third distal press-fit surface 30.4 of the outlet-valve body 30 engages a fourth distal press-fit surface 40.2 of the outlet fitting 40, wherein the proximal press-fit surfaces 30.3, 40.1 are disposed radially outwards of the distal press-fit surfaces 30.4, 40.2. Consequently, a stepped press-fit structure is formed which results in a very tight connection.

When the outlet module 15 is fully assembled, it can be connected to the main body 2 as described above. It is also possible to test the outlet module 15 before it is connected with the main body 2. If any production error is found at this stage, the outlet module 15 can be replaced without the need to discard the entire fuel pump.

As mentioned above, the outlet passage 33 is partially defined by the outlet-valve body 30. Specifically, the outlet passage 33 comprises a proximal portion 33.1, in which the second spring member 38 and the second valve member 37 of the outlet valve 35 are received, and a distal portion 33.3, which is mainly formed inside a fitting cavity 41 of the outlet fitting 40. The proximal portion 33.1 and the outer portion 33.3 are symmetrical to the outlet axis A and are connected by a plurality (e.g. six) of intermediate portions 33.2 that are parallel to the outlet axis A but radially offset therefrom. These intermediate portions 33.2 are tangentially offset (i.e. distributed circumferentially) by 60° with respect to each other. The proximal portion 33.1 and the intermediate portions 33.2 are produced by machining operations performed on the outlet-valve body 30, e.g., by drilling. Since the axial positions of the first traverse portions 27.2 axially overlap with those of the intermediate portions 33.2, they are tangentially offset so that one first traverse portion 27.2 is disposed between two intermediate portions 33.2. The radial offset of the intermediate portions 33.2 from the outlet axis A allows them to bypass the outlet-valve cavity 31 and allows for parts of the relief valve 23 and the outlet valve 35 to be positioned close to the outlet axis A in axial positions that overlap with those of the intermediate portions 33.2.

### LEGEND OF REFERENCE NUMBERS

1 fuel pump
2 main body
3 pumping chamber
4 pumping plunger
5 inlet passage
6 inlet valve
8 damping volume
9 receptacle
10 receptacle opening
11 inner threading
12 second sealing portion
13 annular chamber
15 outlet module
16 dual-valve assembly
17 relief-valve module
20 relief-valve body
20.1 first abutment surface
20.2 second abutment surface
20.3 first proximal press-fit surface
20.4 first distal press-fit surface
21 relief-valve cavity
22 first distal insertion opening
23 relief valve
24 first seat member
24.1 through-bore
25 first valve member
25.1 head
25.2 shaft
25.3 ball
26 first spring member
27 relief passage
27.1 valve portion
27.2 first traverse portion
27.3 second traverse portion
30 outlet-valve body
30.1 second proximal press-fit surface
30.2 second distal press-fit surface
30.3 third proximal press-fit surface
30.4 third distal press-fit surface
31 outlet-valve cavity
32 second distal insertion opening
33 outlet passage
33.1 proximal portion
33.2 intermediate portion
33.3 distal portion
34 outlet
35 outlet valve
36 second seat member
37 second valve member
38 second spring member
40 outlet fitting
40.1 fourth proximal press-fit surface
40.2 fourth distal press-fit surface
41 fitting cavity
43 outer threading
44 drive profile
45 proximal insertion opening
46 first sealing portion
47 knife-edge element
A outlet axis
D distal side
P proximal side

1. A fuel pump comprising a main body and an outlet module, the main body defining:
a pumping chamber with a pumping plunger arranged to reciprocate within the pumping chamber;
an inlet passage at least indirectly connecting a low-pressure inlet of the fuel pump to the pumping chamber, an inlet valve being adapted to selectively enable flow through the inlet passage to the pumping chamber; and
a receptacle, which is open towards a distal side and which extends into the main body along an outlet axis towards a proximal side so that the receptacle communicates with the pumping chamber,
the outlet module being at least partially received in the receptacle, being connected to the main body in a fuel-tight manner, and comprising:
an outlet passage at least indirectly connecting the pumping chamber to a high-pressure outlet of the fuel pump,
an outlet valve adapted to selectively enable flow through the outlet passage to the outlet,
a relief passage at least indirectly connecting the outlet passage, downstream of the outlet valve, to the pumping chamber, and
a relief valve adapted to selectively enable flow through the relief passage to the pumping chamber,
wherein the outlet module comprises an outlet-valve body, which at least partially defines the outlet passage and which at least partially receives the outlet valve, and a relief-valve body, which at least partially defines the relief passage and which at least partially receives the relief valve, wherein the relief-valve body is at least partially received in an outlet-valve cavity of the outlet-valve body.

2. The fuel pump according to claim 1, wherein the outlet module comprises an outer threading engaging an inner threading of the main body inside the receptacle, the inner threading and outer threading being concentrically disposed around the outlet axis.

3. The fuel pump according to claim 1, wherein the outlet module comprises a first sealing portion that engages a second sealing portion of the main body inside the receptacle, wherein at least one sealing portion comprises an annular knife-edge element that cuts into the other sealing portion to create a knife-edge seal.

4. The fuel pump according to claim 1, wherein the outlet module comprises an outlet fitting in which the outlet-valve body is at least partially received and which is connected to the main body.

5. The fuel pump according to claim 4, wherein the outlet-valve body is press-fitted into the outlet fitting.

6. The fuel pump according to claim 1, wherein the relief-valve body is press-fitted into the outlet-valve body.

7. The fuel pump according to claim 5, wherein at least one press-fit connection is achieved using at least two pairs of cooperating surfaces, which pairs of surfaces are axially and radially offset relative to each other.

8. The fuel pump according to claim 1, wherein the relief-valve body comprises a relief-valve cavity with a first distal insertion opening on the distal side, through which the relief valve is at least partially inserted into the relief-valve cavity during assembly.

9. The fuel pump according to claim 1, wherein the relief valve comprises a first seat member, a first valve member and a first spring member for biasing the first valve member against the first seat member, the first valve member and the first spring member being disposed in the relief-valve cavity and the first seat member being press-fitted into the relief-valve cavity.

10. The fuel pump according to claim 9, wherein the first valve member is at least mostly disposed on the proximal side of the first seat member and engages the first seat member from the proximal side in a closed position of the relief valve, and the first spring member is disposed on the proximal side of the first seat member and engages a first abutment surface of the relief-valve body.

11. The fuel pump according to claim 1, wherein the outlet-valve body comprises a second distal insertion opening on the distal side, through which the outlet valve and the relief-valve body are at least partially inserted into the outlet-valve cavity during assembly.

12. The fuel pump according to claim 1, wherein the outlet valve comprises a second seat member, a second valve member and a second spring member for biasing the second valve member against the second seat member, the second spring member engaging a second abutment surface of the relief-valve body.

13. The fuel pump according to claim 12, wherein the outlet-valve body forms the second seat member.

14. The fuel pump according to claim 1, wherein the outlet passage comprises a proximal portion, in which the outlet valve is at least partially received, a distal portion and a plurality of intermediate portions connecting the proximal portion and the distal portion, the outlet axis traversing the proximal portion and the distal portion and the intermediate portions being offset from the outlet axis.

15. The fuel pump according to claim 8, wherein the relief passage comprises a valve portion inside the relief-valve cavity adjacent to the relief valve, at least one first traverse portion connected to the valve portion and traversing the relief-valve body to an outside thereof, and at least one second traverse portion communicating with at least one first traverse portion, traversing the outlet-valve body to an outside thereof and communicating with the pump chamber.

16. An outlet module for a fuel pump comprising a main body, which defines:
a pumping chamber with a pumping plunger arranged to reciprocate within the pumping chamber;
an inlet passage at least indirectly connecting a low-pressure inlet of the fuel pump to the pumping chamber, an inlet valve being adapted to selectively enable flow through the inlet passage to the pumping chamber; and
a receptacle, which is open towards a distal side and which extends into the main body along an outlet axis towards a proximal side so that the receptacle communicates with the pumping chamber,
the outlet module being adapted to be at least partially received in the receptacle, being connected to the main body in a fuel-tight manner, and comprising:
an outlet passage at least indirectly connecting the pumping chamber to a high-pressure outlet of the fuel pump,
an outlet valve adapted to selectively enable flow through the outlet passage to the outlet,
a relief passage at least indirectly connecting the outlet passage, downstream of the outlet valve, to the pumping chamber, and
a relief valve adapted to selectively enable flow through the relief passage to the pumping chamber,
wherein the outlet module comprises an outlet-valve body, which at least partially defines the outlet passage and which at least partially receives the outlet valve, and a relief-valve body, which at least partially defines the relief passage and which at least partially receives the relief valve, wherein the relief-valve body is at least partially received in an outlet-valve cavity of the outlet-valve body.

17. The fuel pump according to claim 6, wherein at least one press-fit connection is achieved using at least two pairs of cooperating surfaces, which pairs of surfaces are axially and radially offset relative to each other.
